(19) United States
(12) Patent Application Publication
(10) Pub. No.: US 2026/0336369 A1
(43) Pub. Date: Oct. 29, 2026

(54) COMBINATION OF A DRIVER AND A WINDOW PANE AS COMPONENTS OF A WINDOW LIFT DEVICE OF A MOTOR VEHICLE

(71) Applicant: Kiekert Aktiengesellschaft, Heiligenhaus (DE)

(72) Inventors: Andrew Ziehm, South Lyon, MI (US); Jesus Galan, Düsseldorf (DE); Ivica Stanic, Dormagen (DE); Joachim Hesselschwerdt, Leverkusen (DE)

(73) Assignee: Kiekert Aktiengesellschaft, Heiligenhaus (DE)

(21) Appl. No.: 19/192,440

(22) Filed: Apr. 29, 2025

(51) Int. Cl. B60J 1/17; B25B 27/00; B29C 45/16; B29L 31/30; B60J 1/08

(52) U.S. Cl. CPC B60J 1/17; B25B 27/0035; B60J 1/085; B29C 45/16; B29K 2995/0046; B29L 2031/30

(57) ABSTRACT

A combination includes a driver and a window pane as components of a window lifter device of a motor vehicle. The driver is equipped with an inner clamping element and an outer clamping element, which together form an insertion gap for the window pane. A clamping element is equipped with a locking means which, when the window pane is mounted in the insertion gap, engages in a non-positively locking manner in an opening in the window pane. According to the invention, the clamping element equipped with the locking means is predominantly rigid and the opposite clamping element is designed to be elastically deformable. When the window pane is inserted lengthwise into the insertion gap, the elastic clamping element is deformed. In this way, the window pane initially moves transversely relative to the locking means and, in the assembled state, the locking means engages in the opening of the window pane while the elastic clamping element snaps back.

The invention relates to the combination of a driver and a window pane as components of a window lift device of a motor vehicle, wherein the driver is equipped with an inner clamping element and an outer clamping element, which together form an insertion gap for the window pane, and wherein a clamping element is equipped with a locking means which engages in an opening in the window pane in a non-positively locking manner when the window pane is mounted in the insertion gap.

Window lift devices in motor vehicles are typically installed inside an associated motor vehicle door and in particular a motor vehicle side door. For this purpose, the window lift device substantially makes use of a cable pull arrangement with the help of which a window pane is extended and lowered. Side guide rails are usually used to ensure the guidance of the window pane. The cable pull arrangement is generally driven by an electric motor, which is also located inside the vehicle door and may have a downstream gear mechanism. In principle, a mechanical actuation of the cable pull arrangement is also conceivable. With the help of the electric motor, the cable pull arrangement is acted upon in such a way that the drivers attached to the cable pull arrangement move the window pane up and down. For this purpose, the drivers are guided using the guide rails.

Such window lift devices in motor vehicles, as shown for example in US 2010/0043297 A1 in FIG. 6 therein, are enjoying increasing popularity. This can be substantially attributed to the particularly convenient and electric-motor-driven operation of the window panes. In addition, electric-motor-operated window lift devices are not only easy and convenient to operate, but also generally ensure that any tilting of the window pane in a frame or relative to the guides or guide rails is not, or is no longer, observed.

In connection with the installation of such window lift devices inside a motor vehicle door, the mounting of the window pane on the driver is of particular importance. In fact, the driver is in turn connected to the cable pull arrangement of the window lift device or is moved together with the cables by an electric motor (or mechanically or otherwise). It is particularly important to ensure that the window pane is properly secured to the (usually) two drivers. For this purpose, each driver defines the insertion gap between the inner and outer clamping element. This means that the two clamping elements initially define the driver, which is usually U-shaped, with an inner clamping element and an outer clamping element. The insertion gap for the window pane is formed between the two clamping elements.

To ensure that the window pane cannot come loose from the associated clamping element and thus also from the insertion gap, at least one of the clamping elements is equipped with the locking means, which, when the window pane is mounted in the insertion gap, engages in a corresponding opening in the window pane with a non-positive fit. For example, this is the procedure for the generic prior art according to DE 10 2018 206 224 A1.

Another prior art, as disclosed by DE 10 2004 034 144A1, relates to a driver for fastening a window pane of a motor vehicle to a guide device of a window lift. A fastening element is provided for this purpose. The fastening element is held pre-assembled on the driver and, with the window pane in the assembled position, is connected through a recess in the window pane to a clamping jaw located behind the window pane with respect to the pre-assembled position of the fastening element. This results in a relatively complex assembly process.

The previously mentioned and generic state of the art according to DE 10 2018 206 224 A1 concerns a window lift assembly for a vehicle window lift which has or is intended to have a driver secured against improper release. The driver has an elastically displaceable inner bracket extending at least partially along an inner side of the window pane. In addition, an outer bracket is provided which extends at least partially along an outer side of the window pane. The inner bracket has a locking portion that engages in a fastening opening in the window pane. This prevents the driver from being accidentally released from the window pane, as the locking portion of the inner bracket can only be disengaged from the fastening opening from the inside of the window pane by elastically displacing the inner bracket.

The prior art has proven itself in principle, but still offers room for further improvement. The mounting of the driver thus requires an elastic displacement of the elastic inner bracket with the locking portion, intended to be carried out from the inside of the window pane. On the one hand, this obviously means that a specific installation position for the window pane is specified, and on the other hand this requires a special tool. Although this is mainly discussed in connection with a repair, it is also likely to be used predominantly during initial assembly. This is where the invention steps in.

The invention is based on the technical problem of further developing such a combination of a driver and an associated window pane as components of a window lift device of a motor vehicle in such a way that the assembly is further simplified compared to the previous procedure.

To solve this technical problem, the generic combination according to the invention is characterized in that the clamping element equipped with the locking means is predominantly rigid and the opposite clamping element is elastically deformable, wherein when the window pane is inserted lengthwise into the insertion gap, the elastic clamping element is deformed so that the window pane initially gives way transversely relative to the locking means and, in the assembled state, the locking means engages in the opening while the elastic clamping element snaps back.

In contrast to the generic state of the art according to DE 10 2018 206 224A1, the procedure is therefore such that the locking means is provided and designed on the predominantly rigid clamping element as a component of the driver. In contrast, the opposite clamping element is designed to be elastically deformable without any locking means. The invention is based on the knowledge that the driver is generally made of plastics material. The rigid design of the clamping element equipped with the locking means can be realized by using a plastics material with low elasticity at this point, for example polyamide (PA), polycarbonate (PC), but also other thermoplastic plastics materials such as polyethylene (PE), polypropylene (PP) or the like. In contrast, the elastically deformable clamping element is predominantly made of an elastomeric plastics material such as styrene-butadiene rubber (SBR), acrylate rubber (ACM), acrylonitrile-butadiene rubber (NBR), to name just a few examples.

In this context, it is also advantageous to produce the driver in a two-component injection molding method. This allows the two plastics materials for the predominantly rigid clamping element with the locking means on the one hand and the opposite, elastically deformable clamping element on the other hand to be produced in a common injection molding process and combined with each other to form the driver. Of course, it is also within the scope of the invention to use one and the same plastics material for the production of the driver. In this case, a plasticizer, an elastomer, etc. in the sense of a plastics material mixture may be added to the elastically deformable clamping element in order to bring about the different elasticities.

In any case, the clamping element equipped with the locking means and predominantly rigid in design and the, in contrast, elastically deformable clamping element differ, for example, in terms of their Shore A hardness, which for the elastic clamping element is in the range of 50 to 90 Shore A, whereas the rigid clamping element or the plastics material used at this point is equipped with Shore A hardnesses of significantly more than 90, if this can even be measured at this point. In fact, Shore D hardnesses in the range of 40 and more can generally be assumed here. The Shore A hardness can be determined in accordance with the international standard ASTM D 2240, which is also used to determine the Shore D hardness.

In any case, the design according to the invention allows particularly simple and functional assembly. When the window pane is inserted into the insertion gap of the driver, the elastically deformable clamping element is predominantly deflected and deformed. In contrast, the rigid clamping element experiences no or at most only slight deformation. As a result, the window pane initially deflects transversely relative to the locking means when it is inserted into the insertion gap and in turn ensures that this deflection automatically deflects the elastically deformable clamping element. The elasticity of the clamping element in question thus allows this transverse deflection of the window pane in comparison to the longitudinal movement into the insertion gap. As soon as the window pane or the opening in the window pane interacting with the locking means has passed the locking means, the locking means can engage in the opening. Here the elastic clamping element snaps back.

The opening in question in the window pane is generally a through-opening, for example a continuous cylindrical hole. In principle, however, the opening in the window pane can also be designed as a blind opening in such a way that only the locking means engages in the opening in question and then rests against the bottom of the blind opening. However, for reasons of ease of manufacture of the window pane, a continuous opening or cylindrical hole will predominantly be used.

In this context, the design is usually such that the inner clamping element is equipped with the locking means. The outer clamping element is the one that is oriented towards the outside of the corresponding vehicle door, or the outer door panel. In contrast, the inner clamping element is oriented adjacent to the inner door panel. As a result, the inner clamping element is designed to be elastically deformable. Moreover, the inner clamping element and the locking means are formed as one piece. This applies advantageously to both clamping elements and to a base connecting the two clamping elements. In this way, the two clamping elements and the base define the previously mentioned U-shaped driver in cross section.

According to a further advantageous embodiment, the locking means has a guide bevel for a lower edge of the window pane. The invention is based on the further finding that the window pane is inserted into the insertion gap of the driver in the longitudinal direction in such a way that to accomplish this, the lower edge of the window pane is inserted first into the insertion gap. Accordingly, the opening interacting with the locking means is located at the relevant lower edge of the window pane.

In this way, a particularly intuitive and functional installation of the window lift device is achieved and provided. This is because the cable pull arrangement, including the drive, is first mounted together with the two guide rails inside the corresponding vehicle door in an opening in the inner door panel. For example, the two drivers may be slidably fastened on the guide rails. The two drivers are also connected to the cable pull arrangement. If the window pane is now inserted with its lower edge first into the relevant insertion slot of the corresponding driver, the guide bevel, which is usually provided on the head side of the inner clamping element, initially interacts with the lower edge of the window pane. As a result, the lower edge of the window pane is moved transversely along the guide bevel provided on the head side of the relevant clamping element, or the window pane deviates transversely relative to the locking means. This is easily possible because the opposing and elastically deformable outer clamping element allows it. As soon as the window pane, or its lower edge, reaches the base of the driver and thus the bottom of the insertion gap, the locking means can engage in the opening of the window pane. At the same time, the previously deformed elastic clamping element snaps back, as part of the driver.

As a result, the window pane can be installed particularly easily and intuitively and is at the same time securely connected to the driver by the locking means that engages in the opening. It is practically impossible to manipulate or attempt to manipulate this locking connection between the driver according to the invention and the window pane, so that access to the vehicle door equipped therewith by an attempt to push down the window pane is also prevented.

According to the invention, a separation between the window pane and the driver can only be achieved by pivoting the window pane with its lower edge out of a receptacle formed between the locking means and the base. Such a pivoting out from the receptacle is only possible from the inside of the vehicle door, and only with the use of a disassembly tool. In fact, the lower side of the window pane cannot be tampered with in an attempted break-in, because it is recessed inside the vehicle door and is therefore inaccessible.

Rather, to disassemble the window pane, a mandrel is typically provided as a dismantling tool opposite the driver, which can be inserted into an opening in the rigid inner clamping element and acts transversely on the window pane. By applying this transverse load to the window pane at its lower edge using the mandrel, the lower edge can be removed from the receptacle between the locking means and the base and the window pane can then be pulled upwards out of the insertion gap. This is possible because the transverse movement is accompanied by the locking means emerging from the opening in the window pane, or at the lower edge of the window pane.

In any case, the combination of the driver and the window pane according to the invention is not only particularly easy to assemble at the factory, but also prevents any unauthorized manipulation. At the same time, it is still possible to dismantle the window pane, for example after an accident or to repair the vehicle door. For this purpose, a simple disassembly tool in the form of a mandrel can be used. These are the main advantages.

The invention is explained in greater detail below with reference to drawings which show only one exemplary embodiment. In the drawings:

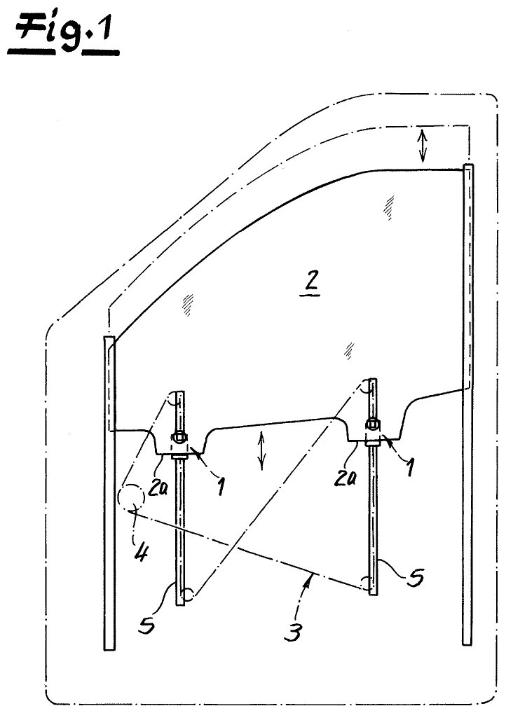

FIG. 1 schematically shows the combination according to the invention of a driver and a window pane as components of a window lift device of a motor vehicle,

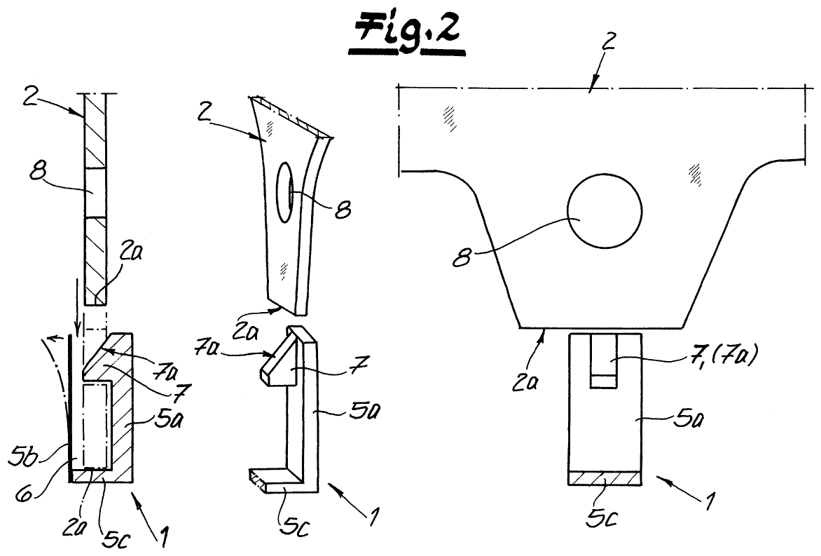

FIG. 2 the combination of the driver and the window pane in the region of the lower edge of the window pane in an overview,

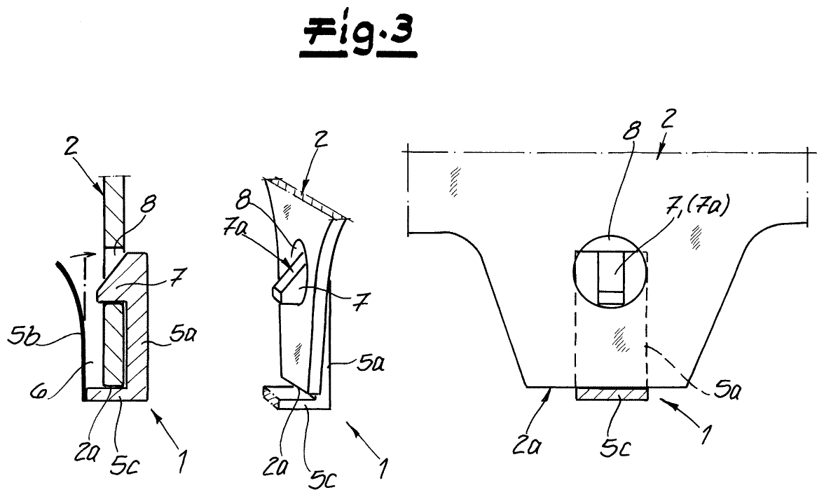

FIG. 3 the assembly process of the window pane in the insertion gap of the driver,

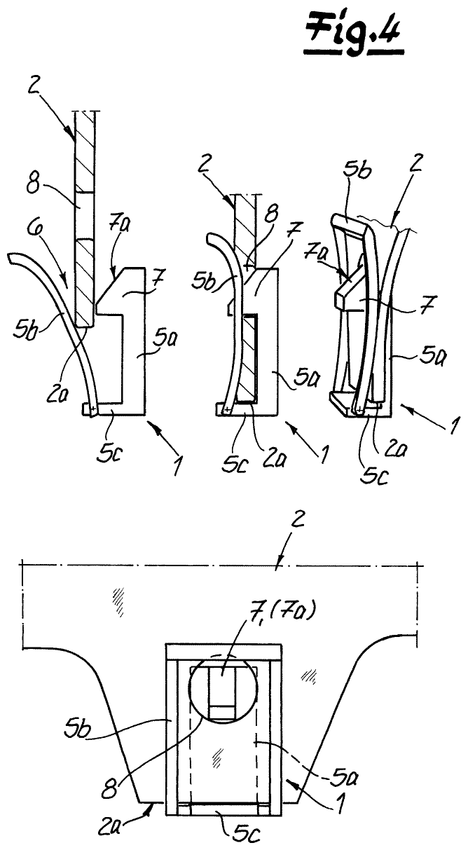

FIG. 4 shows a modified embodiment of the driver during a mounting process and

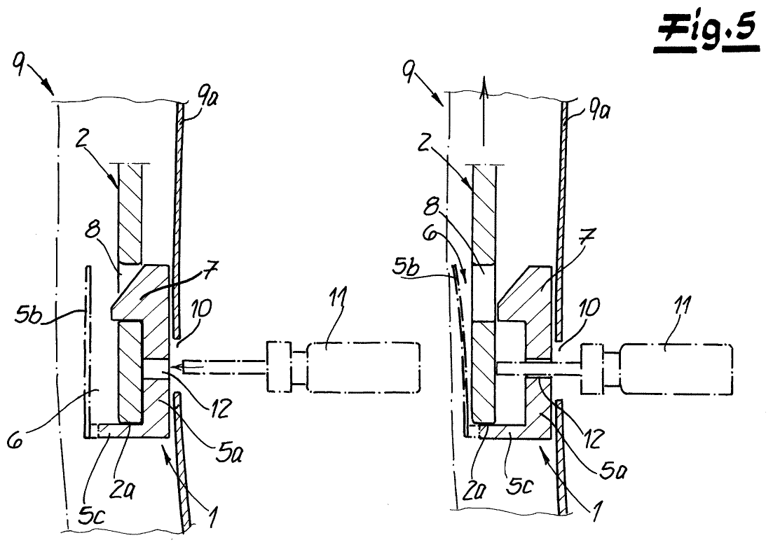

FIG. 5 schematically shows the disassembly of the window pane fixed to the driver.

The figures show the combination of a driver 1 and a window pane 2 as part of a window lift device 1, 2, 3, 4, 5. For this purpose, the window lift device 1, 2, 3, 4, 5 has, in addition to two drivers 1 for the window pane 2, a cable pull arrangement 3 and an electric motor drive 4 for the cable pull arrangement 3. The two drivers 1 are not only connected to the cable pull arrangement 3, but also move along guide rails 5 according to the exemplary embodiment. The same applies to the window pane 2 carried by the two drivers 1, which in this way performs movements along the double arrow in FIG. 1, i.e., can be extended and lowered. This is done by means of the electric motor drive 4, which for this purpose drives the individual cables of the cable pull arrangement 3 in a known manner, so that the drivers 1 connected thereto are moved along the guide rails 5.

The window pane 2 follows the movement of the two drivers 1. For this purpose, the window pane 2 is inserted with its lower edge 2a into an insertion gap 6 formed by the clamping element 1, which can best be seen in FIG. 2. In fact, the driver 1 according to the exemplary embodiment is U-shaped with two opposing clamping elements 5a, 5b and a base 5c. A locking means 7 is arranged on one of the clamping elements 5a, 5b. According to the exemplary embodiment, the locking means 7 is a locking lug 7 which additionally has a guide bevel 7a, described in more detail below. It can be seen that the locking means or the locking lug 7 according to the exemplary embodiment is triangular in side view, wherein the guide bevel 7a describes the hypotenuse of a right triangle formed at this point. Of course, this only applies as an example.

The driver 1 is made entirely of plastics material. This also applies to the two clamping elements 5a, 5b and the base 5c as well as the locking means 7, which according to the exemplary embodiment are designed as a one-piece plastics material injection-molded part. The window pane 2 has an opening 8 on its lower edge 2a, into which the locking means 7 engages in the assembled state.

It can be seen that both clamping elements 5a, 5b are arranged opposite each other and stand largely perpendicular to the base 5c. As a result, the clamping element 1 is largely U-shaped, which defines the insertion gap 6 for the window pane 7, or for the lower edge 2a of the window pane 2 in its interior. That is, the driver 1, together with an inner clamping element 5a and an outer clamping element 5b, forms the insertion gap 6 for the window pane 2. For this purpose, one of the clamping elements 5a, 5b, according to the exemplary embodiment, the inner clamping element 5a, is equipped with the locking means 7. When the window pane 2 is assembled in the insertion gap 6, the locking means 7 engages in the opening 8 in the window pane 2 in a non-positively locking manner. In principle, a positive fit between the locking means 7 and the opening 8 is also conceivable. According to the exemplary embodiment, however, it is sufficient if the locking means 7 engages with a non-positive fit in the opening 8, thus preventing the window pane 2 from being removed again from the insertion gap 6.

The outer clamping element 5b points, as shown in FIG. 1, towards the exterior of the motor vehicle or the motor vehicle door 9 schematically indicated at this point. In contrast, the inner clamping element 5a faces the interior of the motor vehicle door 9 and consequently an inner door panel 9a shown in FIG. 5. In principle, however, the two clamping elements 5a, 5b can also exchange their roles.

Of particular importance according to the invention is the fact that the inner clamping element 5a equipped with the locking means 7 is predominantly rigid. That is, a rigid and stiff plastics material is used here, as already described in the introduction. In contrast, the opposite outer clamping element 5b is designed to be elastically deformable. Appropriately designed plastics materials are also used here, as explained in the introduction to the description.

In this way, when the window pane 2 is inserted lengthwise into the insertion gap 6, the elastic clamping element 5b is deformed, as can be seen in the transition from FIG. 2 to FIG. 3 and additionally in FIG. 4, in which an additional and separately designed elastically deformable clamping element 5b is shown. In fact, in the variant in FIG. 4 the driver 1 is designed in two parts, namely it is composed of the inner clamping element 5a and the base 5c on the one hand and the separate and opposite elastically deformable outer clamping element 5b connected thereto on the other hand. The elastically deformable clamping element 5b can be integrally formed onto the base 5c, adhesively bonded thereto, or otherwise connected thereto.

In any case, during assembly and as shown in FIGS. 2 and 3, when the window pane 2 is inserted lengthwise into the insertion gap 6 in the direction of the arrow shown there, the window pane 2 initially deflects transversely relative to the locking means 7, as another arrow in FIG. 2 indicates. This transverse deflection occurs automatically in the context of the exemplary embodiment in that the window pane 2 meets, with its lower edge 2a, the guide bevel 7a of the locking means 7 during the longitudinal movement shown there and thus deflects transversely. This transverse movement of the window pane 2 is permitted by the fact that the clamping element 5b is automatically elastically deformed and deflected during this process. As soon as the window pane 2 has reached a bottom, which is formed by the base 5c, of the insertion gap 6 with its lower edge 2a, the previously elastically deformed clamping element 5b can snap back because, during this process, the locking means 7 simultaneously engages in the opening 8 of the window pane 2. Now the driver 1 is locked to the window pane 2.

It can be seen that according to the exemplary embodiment, the inner clamping element 5a is equipped with the locking means 7. In principle, this procedure can of course also be reversed. In this case, the rigid clamping element 5a equipped with the locking means 7 represents the outer clamping element 5a, whereas the elastically deformable clamping element 5b is arranged pointing inwards in this case.

Since the guide bevel 7a of the locking means 7 is arranged on the head side of the associated rigid clamping element 5a, the window pane 2 immediately and initially meets the guide bevel 7a when inserted into the insertion gap 6 and the opposite and elastically deformable clamping element 5b is thereby deflected. For this purpose, according to the exemplary embodiment the two clamping elements 5a, 5b are made of different plastics materials which are combined with one another to form the driver 1 in a common two-component injection-molding process.

In the assembled state as shown in FIG. 3, it is now not possible, even in the event of attempted manipulation, to separate the driver 1 from the window pane 2 and thereby, for example, to lower the window pane 2 in order to gain unauthorized access to the interior of the motor vehicle. Rather, such a procedure requires a special tool for disassembly and, moreover, requires the window pane 2 to be acted on from the inside of the motor vehicle door 9, as shown in the individual case in FIG. 5. Here you can see schematically the motor vehicle door 9 and the inner door panel 9a, which is equipped with an opening 10 on its inside. In the region of this opening 10, a disassembly tool 11 can reach through a further opening 12 in the clamping element 5a. In this way, the tool 11 is able to remove the window pane 2, or its lower edge 2a, from a receptacle which is positioned or observed between a lower edge of the locking means 7 and the base 5c in the interior of the insertion gap 6. As soon as the window pane 2 has been displaced in the transverse direction indicated in FIG. 5 using the disassembly tool 11 far enough that the window pane 2 is free with its opening 8 from the locking means 7, the window pane 2 can be moved upwards relative to the window lift device 1, 2, 3, 4, 5 and released from the drivers 1. As stated, this is only possible from the inside of the motor vehicle door 9, wherein this interior is of course not accessible in the event of a planned manipulation attempt, so that such manipulations are practically prevented.

### LIST OF REFERENCE SIGNS

1 driver
2 window pane
2a lower edge
3 cable pull arrangement
4 electric motor drive
5 guide rail
5a, 5b clamping element
5c base
1, 2, 3, 4, 5 window lift device
6 insertion gap
7 locking means, locking lug
7a guide bevel
8 opening
9 motor vehicle door
9a inner door panel
10 opening
11 tool
12 further opening

1. A window lift device comprising:
a window pane with an opening, and
a driver including an inner clamping element and an outer clamping element,
wherein the inner clamping element and the outer clamping element form an insertion gap for the window pane,
wherein the inner clamping element includes a locking means which, when the window pane is mounted in the insertion gap, engages in a non-positively locking manner in the opening of the window pane,
wherein the inner clamping element is predominantly rigid and the outer clamping element is elastically deformable, and
wherein when the window pane is inserted lengthwise into the insertion gap, the outer clamping element is deformed such that the window pane initially deflects transversely relative to the locking means of the inner clamping element and, in an assembled state, the locking means engages in the opening while the inner clamping element snaps back.

2. (canceled)

3. The window lift device according to claim 1, wherein the inner clamping element and the locking means are formed in one piece.

4. The window lift device according to claim 1, wherein the window pane includes a lower edge, and wherein the locking means has a guide bevel for the lower edge of the window pane.

5. The window lift device according to claim 4, wherein the locking means defines a head side of the inner clamping element, and wherein the guide bevel is provided on the head side of the inner clamping element.

6. The window lift device according to claim 1 further including a base, wherein the inner clamping element and the outer clamping element are connected to one another by the base and, in cross section, define the U-shaped driver.

7. The window lift device according to claim 1, wherein the driver is manufactured from plastics material.

8. The window lift device according to claim 7, wherein the driver is made of plastics materials having different elasticity.

9. The window lift device according to claim 7, wherein the driver is manufactured in a two-component injection molding method.

10. The window lift device according to claim 1, wherein the inner clamping element includes a mandrel opening for removing the window pane.

11. The window lift device according to claim 10, wherein the window pane is configured to be removed relative to the driver by inserting a mandrel into the mandrel opening of the inner clamping element to act transversely on the window pane.

12. The window lift device according to claim 5, wherein the guide bevel is configured to interact with the lower edge of the window pane when the window pane is inserted with the lower edge first.

13. The window lift device according to claim 12, wherein the lower edge of the window pane moves transversely along the guide bevel.

14. The window lift device according to claim 13, wherein the outer clamping element is configured to elastically deform as the lower edge of the window pane interacts with the guide bevel.
